(19) United States
(12) Patent Application Publication
(10) Pub. No.: US 2021/0039905 A1
(43) Pub. Date: Feb. 11, 2021

(54) DOCUMENT SHREDDING MACHINE

(71) Applicant: Shred Holdings, LLC, Northbrook, IL (US)

(72) Inventors: Paul Kaufmann, Northbrook, IL (US); Kurt Melia, Buckner, KY (US)

(73) Assignee: Shred Holdings, LLC

(21) Appl. No.: 16/880,092

(22) Filed: May 21, 2020

Related U.S. Application Data
(63) Continuation-in-part of application No. 16/533,125, filed on Aug. 6, 2019.

(51) Int. Cl. B65H 5/22; B02C 18/00; B65H 5/14; B65H 7/14; B65H 7/16

(52) U.S. Cl. CPC B65H 5/222; B02C 18/0007; B02C 2018/0046; B65H 7/14; B65H 7/16; B65H 5/14

(57) ABSTRACT

A stand-alone self-service document shredding machine that receives the documents, shreds them, and securely stores the shredded documents in a receiving bin for later removal. There is a feeder mechanism that feeds the documents yet protects the user from injury when the shredder machine is operating. The shredded documents are disbursed across the receiving bin. The user interfaces with the shredding machine by means of a touch screen and can pay with a credit or debit card or an account set up online.

### CROSS REFERENCE TO RELATED APPLICATION

This application is a continuation in part of U.S. application Ser. No. 16/533,125 filed Aug. 6, 2019, currently pending, which is based on and claims the priority of U.S. provisional patent application Ser. No. 62/715,025 filed Aug. 6, 2018.

### FIELD OF THE INVENTION

This invention relates to document shredding machines and in particular to a stand-alone document shredding machine that safely receives the documents, shreds them, and securely stores the shredded documents for later removal. The user is automatically charged on the user's credit card based on the quantity of documents shredded. Although the term document is used to designate the type of item shredded, it is meant to encompass all forms and thickness of paper, cardboard and other similar media.

### BACKGROUND AND SUMMARY OF THE INVENTION

Currently there are not any good solutions for businesses and consumers to shred small volumes of important documents. Small “secure” consoles that are periodically picked up are not secure. They are costly to use if they are not completely filled between pick up times as the user pays the monthly rate whether the console is full or not. These consoles are also relatively easy to break into and they are not designed for consumer use. Documents can also sit in the consoles for a month or longer waiting to be picked up. Thus, these consoles provide a poor method for shredding documents at business locations.

One prior device provided a shredder in which the user paid for each minute of shredding time. A disadvantage of this device was that it provided minimal safeguards to protect the user from touching or otherwise engaging the shredder blades. Other self-service or self-contained shredders required that the user feeds the documents into the shredder and paid a fee based on the amount of time that the user uses the shredder. This does not accurately bill the user for the quantity of documents shredded, as one user may be faster in feeding documents than a second person, thus the faster user gets more documents shredded during a given time period. Other previous shredding machines did not provide for a receptacle to securely store the shredded documents, but instead the user had to provide a trash can to receive and dispose of the shredded documents. This required the user to place a trash can under the shredder and empty the very small amounts of shredded documents. Applicant's machine solves this problem by providing a large storage receptacle for receiving the shredded documents.

Applicant's invention immediately shreds the documents and the user only pays for the quantity that is shredded. Also, the shredded documents are stored in a large receiving bin that is secured within the machine and can only be removed by authorized personnel. Applicant's machine also provides for a unique feeder mechanism that protects the user from injury when the shredder machine is operating. There is also a unique shredded document mechanism that distributes the shredded documents throughout the shredded document receiving bin. The user interfaces with the shredding machine by means of a touch screen and can pay with a credit or debit card or an account set up online.

### BRIEF DESCRIPTION OF THE DRAWINGS

FIG. 1 is a front view of the internal components of the shredding machine.

FIG. 2 is a front view of the shredding machine of FIG. 1 on a reduced scale.

FIG. 3 is a perspective view of the document receiving tray in which the user deposits the documents to be shredded.

FIG. 4 is a perspective view of the document sensor used to measure the document height and the pressure plate used to compact the stack of documents to be shredded.

FIG. 5 is a perspective view of the document sensor and the cross bar used to apply pressure to the pressure plate, with the pressure plate removed for clarity to illustrate the document finger feeding channels.

FIG. 6 is a perspective view of the pneumatic air cylinder that drives the pressure plate to compress the documents in the feeder tray.

FIG. 7 is a perspective view of the drive chain that operates, among other things, the movement of the document pusher fingers and the shredded document paddles.

FIG. 8 is a perspective view of the control box that contains the programmable logic controller, microprocessors, power supplies and switches that control all electronic and mechanical aspects of the shredding machine.

FIG. 9 is a top view of the document feeder.

FIG. 10 is a front view of the document feeder.

FIG. 11 is a front perspective view of the user interface touch screen and credit card reader.

FIG. 12 is a rear perspective view with portions removed of the vacuum feeder assembly.

FIG. 13 is an enlarged perspective view of the vacuum feeder assembly and suction cup.

FIG. 14 is a right end perspective view with portions removed of the vacuum feeder assembly and paper shredding mechanism.

### DESCRIPTION OF THE PREFERRED EMBODIMENT

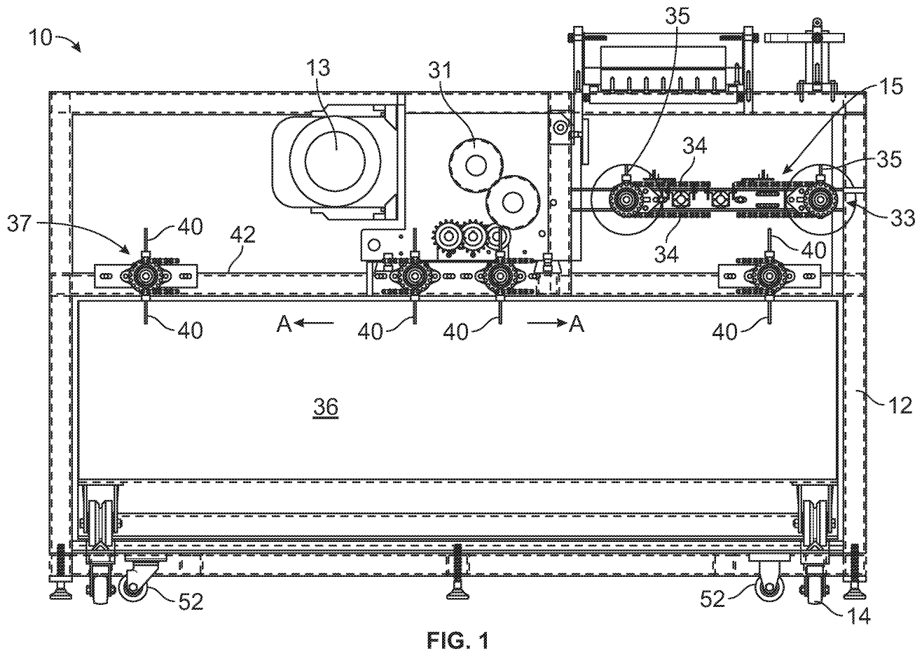

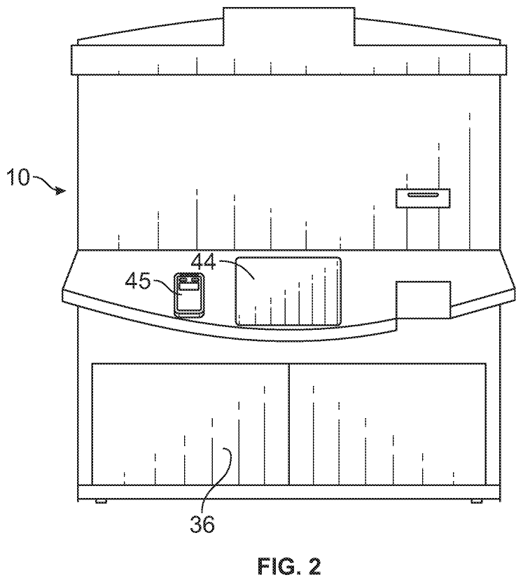

FIGS. 1 and 2 illustrates a shredding machine 10 of the current invention. The shredding machine 10 has an enclosure 12 that houses the shredding machine 10. A motor 13 powers most of the driving components of the shredding machine 10. The shredding machine 10 may be mounted on wheels 14 so that it can easily be transported. The primary components of the shredding machine 10 are a paper shredder mechanism or shredder head 31, a document feed and measuring mechanism 15, a shredded document disbursing mechanism 37, easily removable document storage receptacle 36, touch screen user interface 44 and credit card reader 45 and related electronics. These will be more fully described herein.

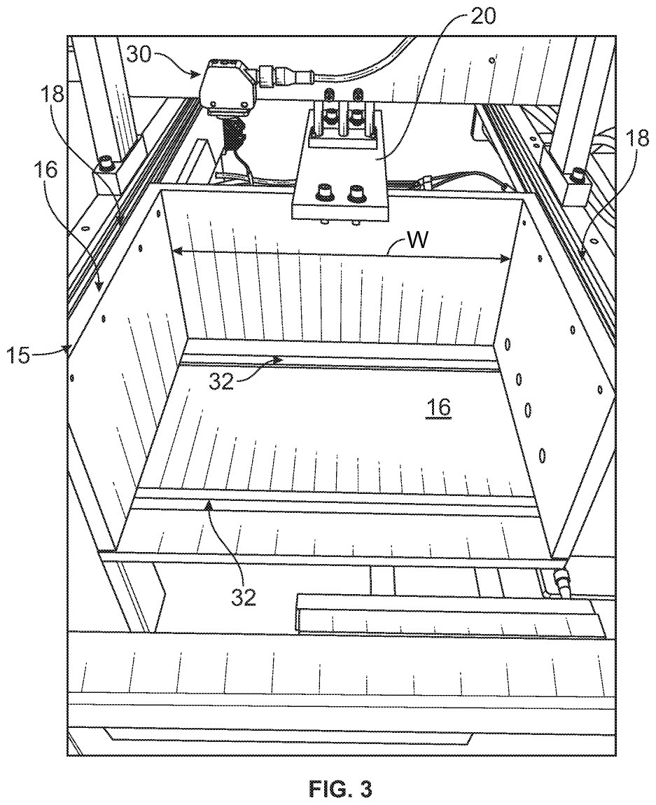

FIG. 3 illustrates a document receiving tray 16 in which the user deposits the documents to be shredded. The documents should preferably be neatly arranged and stacked so that the pages easily fit into the document receiving tray 16 without flowing over the edges of the document receiving tray 16. Legal size and standard letter size documents can be intermixed. A width “W” of the document receiving tray 16 will generally be slightly greater than the width of the documents, thus slightly greater than 8½ inches.

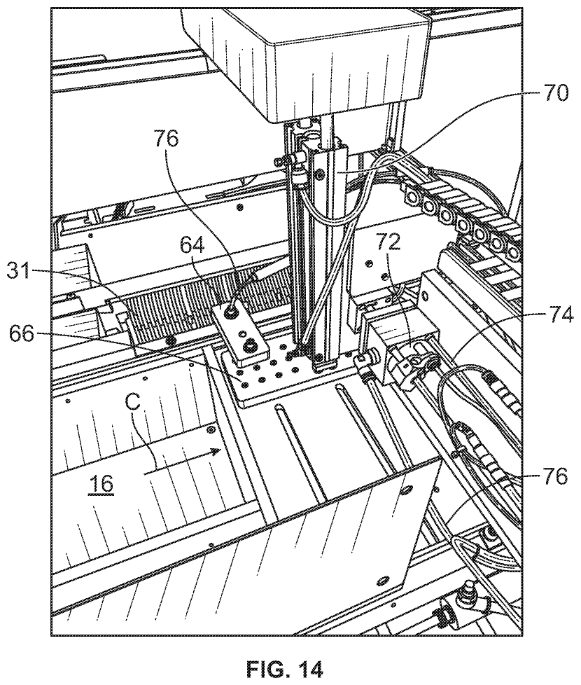

Once the document is placed in the document receiving tray 16, the user activates the “start” cycle by pressing a “start” icon on a touch screen 44. Alternatively, a separate “start” button can be used. The user inserts a credit card or personal identification number. A door 17 in the shredding machine 10 located in front of the receiving tray 16 opens and the receiving tray 16 is moved forward to the front of the shredding machine 10, and through the door 17. The user deposits the documents into the document receiving tray 16 and the document receiving tray 16 is pulled back into the shredding machine 10. Movement of the document receiving tray 16 is accomplished by a pneumatic air cylinder (not seen in FIG. 3) that pushes and pulls the document receiving tray 16 within the shredding machine 10. A pneumatic air cylinder (not illustrated) is connected to a holding tank (not illustrated) that is connected to an air compressor (not illustrated) by means of pressure hoses 19 to maintain a constant pressure in the air pressure system. The document receiving tray 16 moves on rails 18 so that the document receiving tray easily slides within the shredding machine 10. When the user deposits the documents into the document receiving tray 16, he presses a “continue” button or icon on the screen 44. The document receiving tray 16 moves back into a document feeding position as shown by arrow C in FIG. 14 and the door 17 closes and locks so that the user cannot place his or her hands inside the shredding machine 10 and has no access to the internal workings of the shredding machine 10.

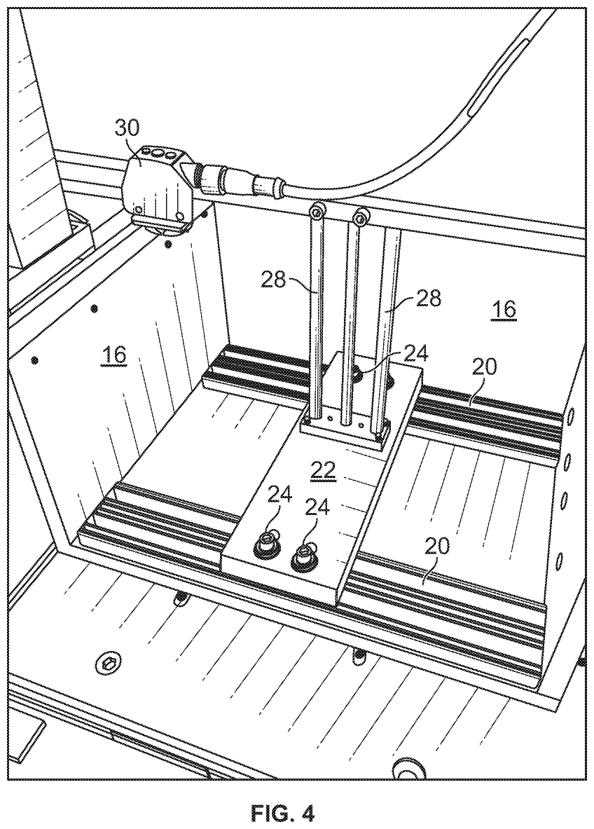

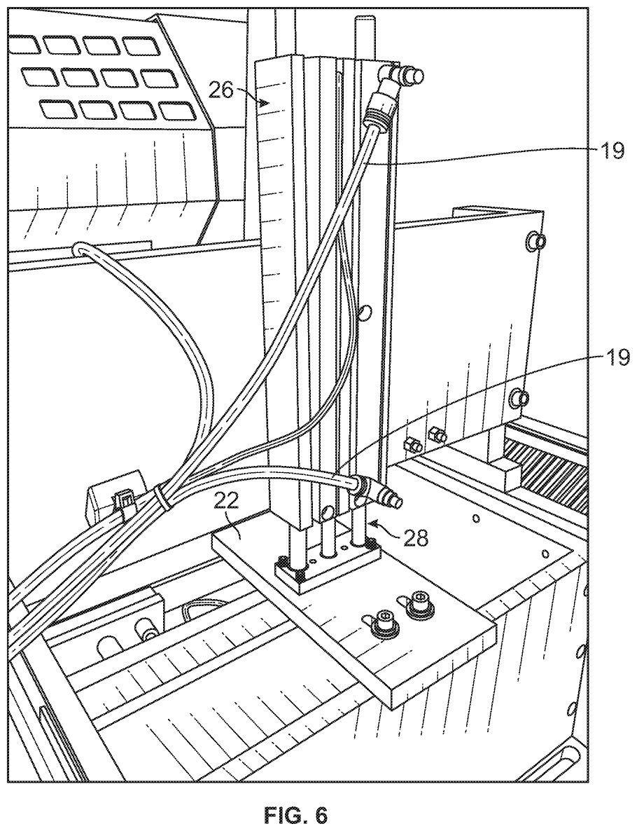

Once the document receiving tray 16 is properly positioned inside the shredding machine 10, a pressure plate 20 (FIG. 4) is activated so that it pushes against the stack of documents. A cross bar 22 is secured to the pressure plate 20 by means of screws or other fasteners 24. Movement of the cross bar 22 and pressure plate 20 is accomplished by means of a pneumatic air cylinder 26 (FIG. 6). The pneumatic air cylinder 26 is connected to the previously described holding tank that is connected to the air compressor. The pneumatic air cylinder 26 controls piston rods 28 that are connected to the cross bar 22 by means of fasteners. When the pneumatic air cylinder is activated, the piston rods 28 compress the stack of documents in the document receiving tray 16 until a predetermined force is exerted by the pressure plate against the stack of documents.

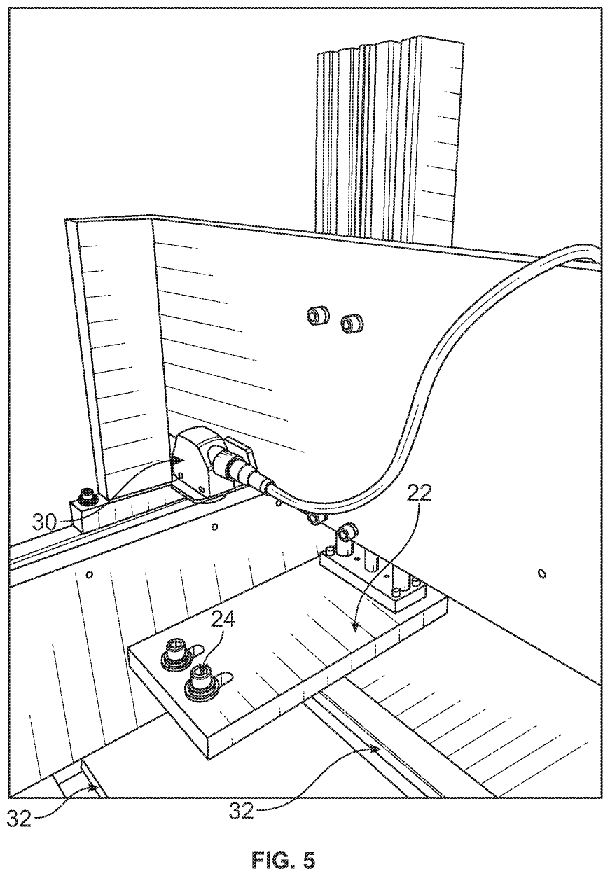

The height of documents in the document receiving tray 16 is then measured by a sensor 30. The sensor is preferably a laser type sensor that accurately measures the height of the documents in the stack. It also detects the lack of documents in the stack. As seen in FIGS. 3-5, the sensor 30 projects the laser beam directly on the stack of documents in the receiving tray 16. Other types of sensors can be used, such as load sensors, but it has been found that the laser sensor 30 is the most accurate and reliable means to measure the quantity of documents. Based on the height of the stack of documents, a programmable controller 46 calculates the number of pages in the stack and charges the user accordingly. Alternatively, the programmable controller 46 can calculate the total weight of the document in the stack based on the thickness of the stack, and charge the user based on weight. Thus, the programmable controller 46 can generate a bill to the user based on either weight or the number of pages, depending on how the owner of the shredding machine 10 wants to bill for the shredder machine's use. The charge to the user is displayed on the screen 44.

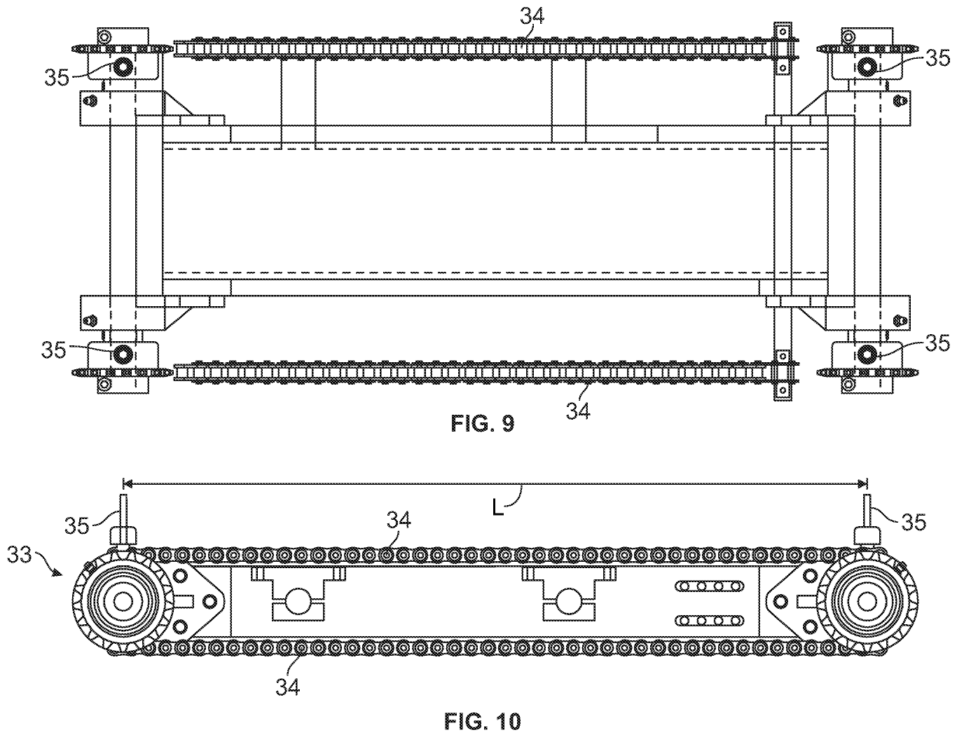

When the door 17 is closed and magnetically latched, and the document receiving tray is in the retracted or feed position, the motor 13 is activated which starts the document feeder 33. The document feeder 33 is comprised of a pair of chain drives 34, with each chain drive 34 having two pusher fingers 35 attached thereto as seen in FIGS. 9 and 10. The document feeder 33 feeds the documents to the shredding mechanism 31, which in turn shreds the documents. The pusher fingers 35 move in a document feeding direction within finger feeding channels 32 in the bottom of the document tray 16 (FIG. 3) to feed approximately the same acceptable number of documents from the bottom of the stack with each cycle of the chain drive 34. In this manner the shredding mechanism 31 is not overloaded with too many documents at one time which could cause the shredding mechanism 31 to jam. The pusher fingers 35 return on the circular chain drive 34 underneath the channels 32, and surface in the channels 32 to again feed the bottom documents from the stack. The length “L” between the pusher fingers 35, as seen in FIG. 10, generally will be about 6½ inches. Thus, the pusher fingers 35 will not strike the walls of the document receiving tray when feeding the documents. As will be described in the alternate embodiment other types of document feeders can be used as long as they feed the documents into the shredding mechanism 31.

The sensor 30 detects when there are no longer any documents in the receiving tray 16 and sends a signal to the programmable controller 46 to initiate stopping the operation of the shredding machine 10. The chain drive 34 runs several cycles to verify that no documents remain in the document receiving tray 16. The chain drive 34 stops with the pusher fingers 35 below the document receiving tray 16. Location sensors verify that the pusher fingers 35 are not protruding up into the finger feeding channels 32 so that they will not interfere with the document receiving tray 16 being pushed forward toward the front of the shredding machine 10 to receive the next batch of documents.

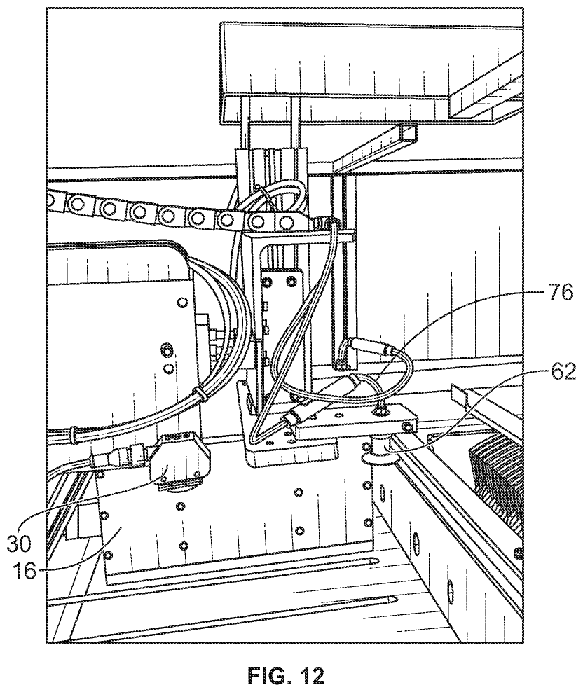

In the alternate embodiment, a vacuum feeding mechanism 60 feeds the documents from the document receiving tray 16 into the shredding mechanism. This embodiment replaces the cross bar 22, fasteners 24, chain drive 34 and pusher fingers 35, and related components that were required to push the documents from the bottom of the document receiving tray 16 into the shredding mechanism 31. The vacuum feeding mechanism 60 is more clearly shown in FIGS. 12-14.

The vacuum feeding mechanism operates by applying a vacuum to one or more suction cups 62 that is mounted on an arm 64. The arm is attached to a base plate 66, that in turn is connected to the bottom of a vertical support arm 68. The vertical support arm 68 is operatively connected to a pneumatic air cylinder 70 that vertically moves the vertical support arm 68 which in turn moves the suction cup arm 64 and suction cup 62 vertically up and down. Horizontal movement of the vacuum feeding mechanism 60 is accomplished by means of a pneumatic air cylinder 72. As seen in FIG. 14, the pneumatic air cylinder 72 is operatively connected to the base plate 66 or vertical support arm 68 so that horizontal movement can be imparted to the base plate 66. The pneumatic air cylinder 72 is mounted in the shredding machine 10 in a manner that allows the pneumatic air cylinder 72 to move vertically in unison with and when the base plate 66 moves vertically. In this manner the base plate 66 and suction cup 62 can move vertically and horizontally. Tie rods 74 hold the pneumatic air cylinder 72 together.

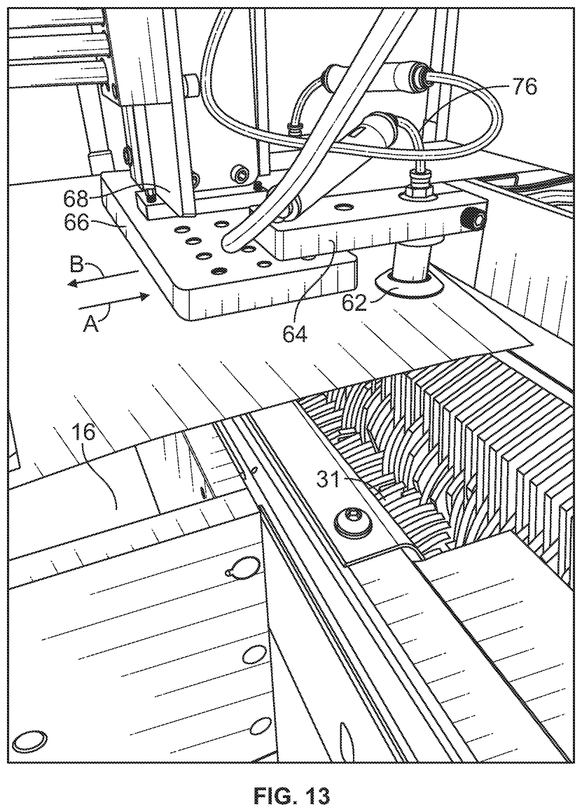

The vacuum feeding mechanism 60 operates differently than the document feeder 33 of the first embodiment. FIG. 14 shows the document receiving tray before it is fully inserted into the shredding machine 10. As illustrated, the document receiving tray 16 is not positioned beneath the base plate 66. When the door 17 is closed and magnetically latched, and the document receiving tray is moved in the document feed position, which is beneath the base plate 66, a vacuum system is activated. This provides a vacuum to various tubes 76 used to supply a vacuum to the suction cup 62 and pneumatic air cylinders 70, 72. With the position illustrated in FIG. 14 as the initial condition, a vacuum is applied to the suction cup 62 and to the pneumatic air cylinder 70 such that it moves vertically downward and engages the top of the stack of documents. The amount of vertical movement and resistance is determined by the pneumatic air cylinder 70. The pneumatic air cylinder 70 then pulls upward vertically raising the base plate 66, suction cup arm 64 and suction cup 62. The documents held by the suction cup 62 are raised with the suction cup 62. The pneumatic air cylinder 72 is energized and moves in a forward direction toward the shredding mechanism 31 as shown by arrow A in FIG. 13. Once the base plate 66 is in its forward position, the vacuum to the suction cup 62 is turned off releasing the documents into the shredding mechanism 31. The pneumatic air cylinder 72 retracts the base plate 66 in the direction of arrow B in FIG. 13 to the initial position. Alternatively, when the base plate 66 is in the forward position, the pneumatic air cylinder 70 may be energized to move the base plate 66 downward toward the shredding mechanism. Again, the vacuum to the suction cup 62 is turned off releasing the documents into the shredding mechanism. The pneumatic air cylinder 70 pulls the base plate 66 upward and the pneumatic air cylinder 72 retracts the base plate 66 to the initial position. Although the above description utilizes a pneumatic air cylinder 72, a gear drive or similar mechanical drive could also be utilized to accomplish the same purpose.

The number of documents pulled up by the vacuum cup 62 will vary depending on the type of paper or other documents being shredded. More porous paper will have a greater number of pages pulled by the suction cup 62 than coated or thicker documents.

During the shredding process, the shredding mechanism 31 shreds the documents into small pieces which are deposited into a receiving hopper 36. As can be expected, the shredded documents are deposited into the same area in the receiving hopper 36 causing a pile or cone of shredded documents to accumulate. This is undesirable as it does not take advantage of the entire volume available in the receiving hopper 36. Also, with the buildup of shredded documents, some will eventually backup into the shredding mechanism 31 or fall outside of the receiving hopper 36. Applicant has solved this problem with the shredded document disbursing mechanism 37 comprising a series of paddles 40 interspaced along a drive chain 42 as seen in FIG. 1. The drive chain 42 moves over the top of the receiving hopper 36 so that when the pile of shredded documents come near the top of the receiving hopper 36, the paddles 40 push the top of the pile and disburse it over the entire receiving hopper 36. There are two drive chains 42 mounted across the front of the shredding machine 10 as seen in FIG. 1. The drive chains 42 move in opposite directions, as shown by the letter “A”, so that the pile of documents is disbursed in opposite directions away from the center of the receiving hopper 36.

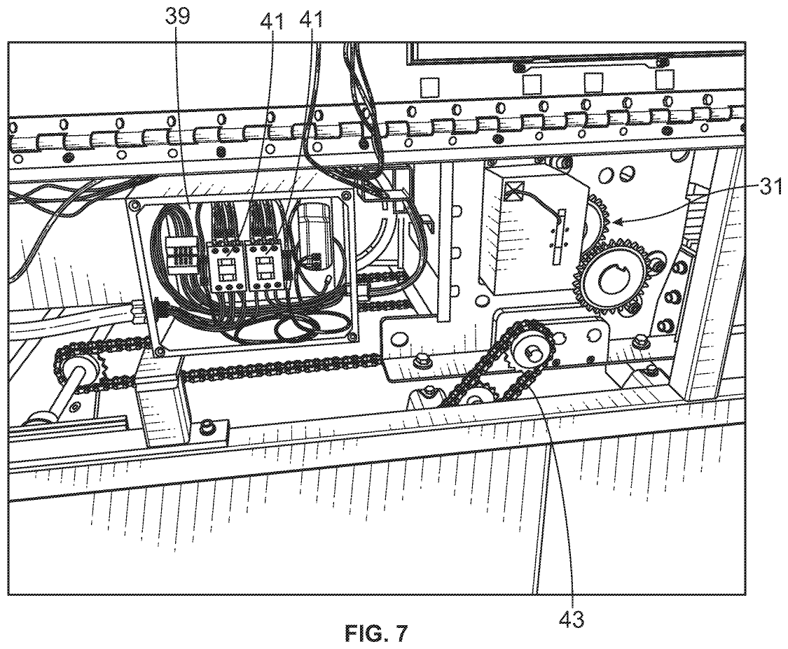

As seen in FIG. 7, there is an angled drive chain 43 that drives drive chains 42 and the paddles 40. In a control box 39 there are reversing contactors 41 that operate, among other things, the movement of the chain drive 34 and pusher fingers 35 and the chain drive 42 and paddles 40.

The entire machine 10 is secure in that the user cannot access the documents once they are moved into the shredding machine 10 and the door 17 closed and locked. Likewise, the receiving hopper 36 is secured within the shredding machine 10 and can only be removed by authorized personnel that have key access to a door 50 allowing access to the receiving hopper 36. This way the shredded documents are not accessible to anyone not having the authority to retrieve them. A heavy bag within the receiving hopper 36 holds the shredded documents, and which may have an open top with a zipper closure to close the bag when it is full and is to be removed. The receiving hopper 36 is on wheels 52 so it can be easily rolled out from the shredding machine 10 when the door 50 is opened. The bag is replaced with a new empty bag and the receiving hopper 36 is rolled back into the shredding machine 10 and the door 50 is closed. Once the door 50 is closed, the system is reset via the software by the servicing technician.

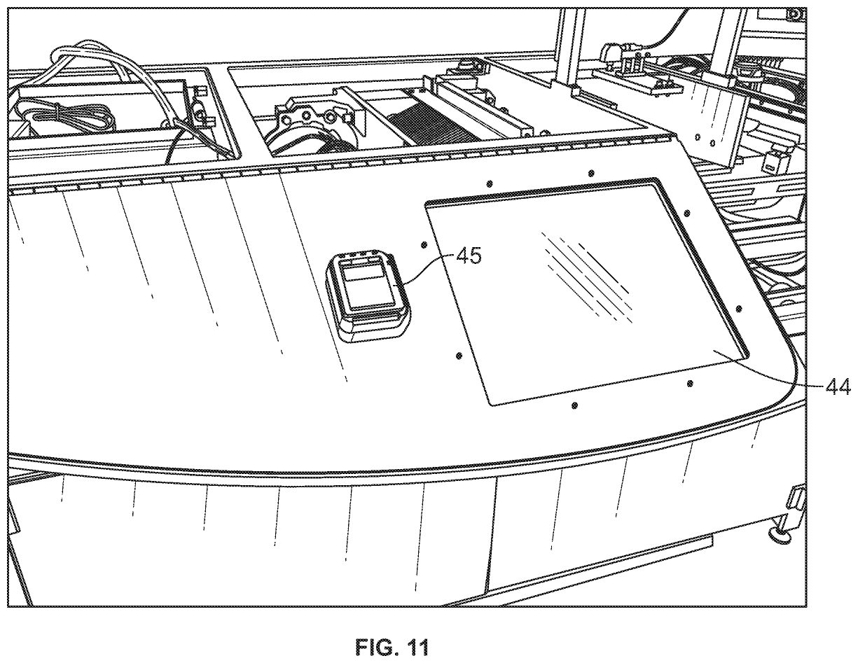

The user interfaces with the machine 10 by means of the touch screen 44 as seen in FIG. 11. The credit/debit card reader 45 is used to charge the user for the quantity of documents shredded. Once there are no more documents in the document receiving tray 16, the user is asked if he has more documents to shred. If the answer is “yes”, the door 17 unlocks and the process starts again. If the answer is “no”, the user is asked if he has any gift cards to be processed before the credit card is charged.

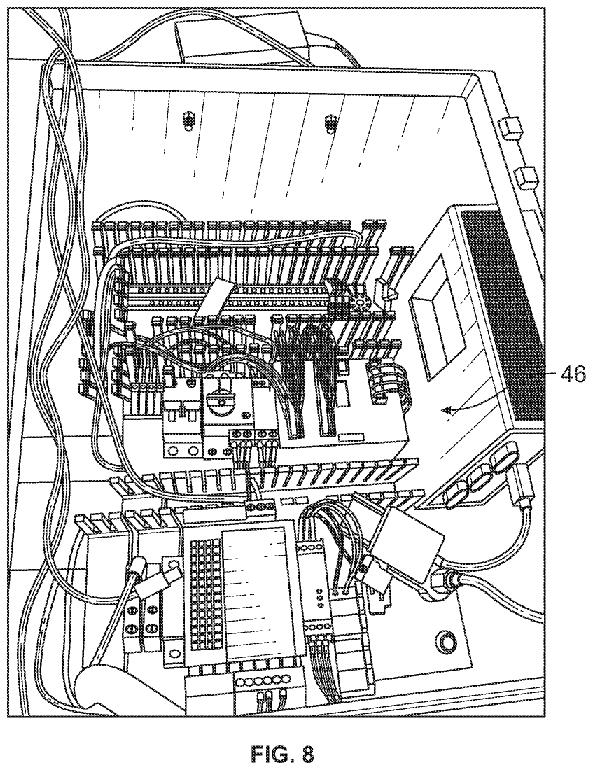

The entire operation of the machine 10 is controlled by a programmable controller 46 (FIG. 8). For example, the operation and sequence of the movement of the document receiving tray 16, the opening and closing of the door 17 to allow access to the document tray 16 and to move the document receiving tray 16 within the shredding machine 10, the pusher fingers 35, the laser sensor 30, the shredding mechanism 31, the chain drives 42 and paddles 40 to knock down the accumulating shredded documents are all controlled by the programmable controller 46. Similarly, the operation and sequencing of the pneumatic air cylinders 70 and 72 and the application of the vacuum to the suction cup 62, is controlled by the programmable controller 46.

The shredding machine 10 includes a telemetry unit that sends information to the machine's owner or operator by means of a cellular connection or secondarily by means of a telephone connection. Various information is collected by the sensors and controller 46. This includes among other things, the quantity of documents shredded during a given time period, the number of cycles of documents fed into the shredding mechanism 31, the amperage draw of the motor 13 at a given time, and other important information to service the shredding machine 10. By knowing the thickness of the stacks of document fed into the shredding machine, the owner or operator of the machine knows when it is time to empty the receiving hopper 36. In an alternative embodiment, if the documents to be shredded are weighed, the owner will know when it is time to empty the receiving hopper based on weight. Other information will give the condition of the machine and when it is time for scheduled or unscheduled maintenance.

Thus, there has been provided a shredding machine that safely receives the user's documents, shreds them, and securely stores the shredded documents for later removal. The user is automatically charged based on the quantity of documents shredded. While the invention has been described in conjunction with a specific embodiment, it is evident that many alternatives, modifications and variations will be apparent to those skilled in the art in light of the foregoing description. Accordingly, it in intended to embrace all such alternatives, modifications and variations as fall within the spirit and scope of the claims.

What is claimed is:

1. A self-contained paper shredding machine comprising:
an enclosure having a front, back, a left side, and a right side;
a motor mounted in the enclosure;
a paper shredding mechanism mounted within the enclosure and driven by the motor;
a door on the front of the enclosure;
a document receiving tray adapted for receiving a stack of individual documents, the receiving tray mounted on a track for movement from a first position within the enclosure and in proximity to the paper shredding mechanism to a second position outside the enclosure and adjacent to the door on the front of the enclosure;
drive means for moving the document receiving tray from the first position to the second position, and for retracting the document receiving tray from the second position to the first position;
sensor means mounted in the enclosure for determining the quantity of documents in the document receiving tray;
document feeding means for feeding the individual documents from the document receiving tray into the paper shredding mechanism where the documents are shredded, the document feeding means comprising at least one vacuum cup operatively mounted on a carriage, the carriage moving from a first position above the document receiving tray in which the vacuum cup engages the document, to a second position in which the document is fed into the paper shredding mechanism;
a shredded document receiving container having an open top, the shredded document receiving container positioned below the paper shredding mechanism for receiving the shredded documents; and
a shredded document disbursing mechanism positioned above the shredded document receiving container for spreading the shredded documents across the shredded document receiving container.

2. The self-contained paper shredding machine of claim 1, and further comprising a first pneumatic air cylinder operatively connected to the carriage for moving the carriage in a vertical direction for picking up documents from the document receiving trays.

3. The self-contained paper shredding machine of claim 2 and further comprising a second pneumatic air cylinder operatively connected to the carriage for moving the carriage in a horizontal direction for moving documents that have been picked up by the suction cup from the document receiving tray to second position in which the document is fed into the shredding mechanism.

4. The self-contained paper shredding machine of claim 3, wherein the shredded document disbursing mechanism comprises a endless drive chain with at least one paddle mounted on and extending out from the endless drive chain, the paddle moving across the open top of the shredded document receiving container, the paddle engaging the shredded documents as they are piled up to the open top.

5. The self-contained paper shredding machine of claim 1, wherein the sensor means comprises a laser sensor for determining the height of the documents in the document receiving tray.

6. The self-contained paper shredding machine of claim 1, and further comprising a controller for controlling the operation of the motor, document feeding means, movement of the document receiving tray, sensor means, and shredded document disbursing means.

7. The self-contained paper shredding machine of claim 1, and further comprising a shredded document receiving container door on the enclosure for providing access to the shredded document receiving container for removal of the shredded document receiving container for emptying.

8. The self-contained paper shredding machine of claim 7, and further comprising a bag in the shredded document receiving container for receiving the shredded documents.

9. The self-contained paper shredding machine of claim 1, and further comprising locking means for locking the door on the front of the enclosure.

10. A method of shredding documents comprising the following steps:
providing an enclosure having a front, back, a left side, and a right side;
providing a motor mounted in the enclosure;
providing a paper shredding mechanism mounted within the enclosure and driving the paper shredding mechanism with the motor;
providing a door on the front of the enclosure;
providing a document receiving tray;
moving the receiving tray from a first position within the enclosure and in proximity to the paper shredding mechanism to a second position outside the enclosure and adjacent to the door on the front of the enclosure;
loading a stack of individual documents in the receiving tray;
moving the document receiving tray from the second position to the first position;
sensing the quantity of documents in the document receiving tray;
feeding the documents from the document receiving tray into the paper shredding mechanism where the documents are shredded,
orienting a shredded document receiving container having an open top below the paper shredding mechanism
receiving the shredded documents in the container; and
providing a shredded documents disbursing mechanism above the shredded document receiving container and spreading the shredded documents across the shredded document receiving container.
